(19) United States
(12) Patent Application Publication
(10) Pub. No.: US 2012/0195585 A1
(43) Pub. Date: Aug. 2, 2012

(54) Mounting Assembly and Systems for Attachment of Objects to a Tripod

(75) Inventor: Paul Wagner, Houston, TX (US)

(73) Assignee: COLE & ASHCROFT, Houston, TX (US)

(21) Appl. No.: 13/364,138

(22) Filed: Feb. 1, 2012

Related U.S. Application Data
(60) Provisional application No. 61/438,369, filed on Feb. 1, 2011.

(51) Int. Cl. G03B 17/00

(52) U.S. Cl. 396/428

(57) ABSTRACT

A universal mounting assembly for the rapid mounting of an object to a stand device is described. The mounting assembly includes a body having a support surface, a front face and an opposed mounting surface, wherein the assembly is configured to mount to a support stand, such as a tripod. The body further includes at least two resilient, adjustable and articulating retaining arms disposed along at least two edges of the body, which allow for the sliding receipt of both the transverse width and longitudinal width, as well as the thickness dimension, of the object to be mounted. The back face of the body further defines at least two receiving ports extending from the support surface and oriented substantially perpendicular to each other. The mounting assembly is particularly useful in mounting a variety of camera phones, small cameras, and video phones to a stand device, such as a tripod.

### CROSS REFERENCE TO RELATED APPLICATIONS

This application claims priority to U.S. Provisional Patent Application Ser. No. 61/438,369, filed Feb. 1, 2011, the contents of which are incorporated herein in their entirety.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The inventions disclosed and taught herein relate generally to mounting devices, and more specifically are related to universal mounting devices for use with camera phones and small digital cameras and video recorders, for mounting the imaging devices to tripods and similar imaging support means.

2. Description of the Related Art

In the recent past digital photography has experienced explosive growth. In 2003, for instance, world wide conventional digital camera sales surpassed 35 mm film based camera sales for the first time. Also in 2003, cellular phone sales that incorporate digital cameras (i.e., so-called “camera phones”) surpassed digital camera sales.

It has been estimated by some sources that camera phone shipments worldwide in the next two years will surpass one billion units per year. In emerging markets—notably China, India, Latin America, Eastern Europe, and Africa—both the total number of mobile phones and the percentage that include camera modules are increasing faster than they are in more advanced regions, such as North America and Europe. In 2005, 45 percent of all mobile phones sold in the U.S. were camera phones, up from 26 percent in 2004, according to InfoTrends. Asia followed a very similar trend. Western Europe had a higher incidence of camera phones at 64 percent, and Japan had a much greater adoption rate with more than 90 percent of all mobile phones sold with camera capabilities both in 2004 and 2005. Even though there are an increasing number of mobile phones with camera capabilities, consumers are using them more likely for spur-of-the-moment picture taking and not for planned events where they are taking along better quality and higher resolution digital cameras. More and more U.S. consumers are using camera phones as their mobile phone of choice The number of camera phones in operation is expected to have almost doubled in 2005, reaching 30 million units, from 16 million in 2004. The penetration of camera phones is also thought to have already surpassed 20 percent of the 115 million U.S. households.

Clearly, mobile phones that incorporate a camera feature have the potential to add another dimension to digital photography. With camera phones, people are able to take their camera with them everywhere they go. An increasing number of mobile phones are being produced and sold with camera capabilities, some with digital resolution on par with those available in stand-alone digital cameras. The convenience factor is very high for the use of camera phones, but the quality and flexibility of digital cameras still far surpass camera phones. InfoTrends reported that the total number of images captured on camera phones exceeded 228 billion in 2010, exceeding the number of photos taken on digital still cameras and film cameras combined. Thus, for many consumers, the camera phone will be their everyday camera.

As camera phones and, even more recently, video phones become more technologically advanced and their use as a viable digital photography and video alternative increases, a means for “hands free” operation is becoming increasingly more desirable. Accordingly, there is an increasing need to provide a quick mount universal platform to hold and support the camera phone and/or video phone on a tripod or similar support for photography and/or video applications.

The inventions disclosed and taught herein are directed to a device which allows a variety of camera phones and similar compact, imaging devices, whether in a protective case or not, to be easily held in place and attached to a tripod for use in supporting the imaging device for photography and imaging applications.

### BRIEF SUMMARY OF THE INVENTION

The inventions described and claimed herein are directed to mounting assemblies for holding a variety of imaging devices, wherein the assemblies include a plurality of size-adjustable, flexible retaining arms for forming a shape for receiving and supporting a desired imaging device of various sizes and thickness, depending upon if such a hand-held imaging device is retained within a protective case or not, and wherein after the imaging device is retained therein, the assembly may be attached to a suitable secondary holder, such as a tripod, for use in obtaining photographic images from the imaging device by the user.

In accordance with a first embodiment of the present disclosure, a holder for attachment to a tripod or similar stand, the holder having a shape for receiving and supporting imaging devices in a manner that leaves the control, display and image capturing functions of the device visible and accessible to a user is described, the holder comprising a planar backing plate having a front face, an opposite back face, and an open leading edge; a first adjustable and articulatable retaining arm extending from a first edge of the backing plate; a second adjustable and articulatable retaining arm extending from a second edge of the backing plate; a third adjustable and articulatable retaining arm extending from a third edge of the backing plate; and a multi-directional connector attached to the back face of the backing plate and having a first end and a spaced apart second end, the first end and second end having female receiving portions formed therein for coupling with the stand, wherein the first arm is oriented substantially perpendicular to the second arm, and wherein the first edge and the third edge are perpendicular to the leading edge of the backing plate.

In accordance with a further embodiment of the present disclosure, a mounting assembly for receiving an imaging device and capable of coupling with a stand in order to take an object image with the imaging device coupled with the stand is described, the mounting assembly comprising a planar backing plate having a front face, an opposite back face, and an open leading edge; a first adjustable and articulatable retaining arm extending from a first edge of the backing plate, the first edge being perpendicular to the leading edge; a second adjustable and articulatable retaining arm extending from a second edge of the backing plate; and a multi-directional connector attached to the back face of the backing plate and having a first end and a spaced apart second end, the first end and second end having female receiving portions formed therein for coupling with the stand, wherein the first arm is oriented substantially perpendicular to the second arm. In further accordance with this aspect of the present disclosure, the mounting assembly further includes a third adjustable and articulatable retaining arm extending from a third edge of the backing plate, the third edge being substantially parallel to the first edge and perpendicular to the leading edge.

In accordance with another embodiment of the present disclosure, a mounting means for receiving a hand-held imaging device such as a mobile phone, camera phone, or the equivalent media device is described, the mounting means comprising a planar support means having a front face, an opposite back face, and an open leading edge; a first adjustable and articulatable retaining means extending from a first edge of the backing plate; a second adjustable and articulatable retaining means extending from a second edge of the backing plate; and a multi-directional connection means attached to the support means and having a female receiving portion formed therein for coupling with a separate support means, wherein the first retaining means is oriented substantially perpendicular to the second retaining means. In further accordance with certain aspects of this embodiment, the first and second retaining means are made of the same material, and are coated with a polymer.

### BRIEF DESCRIPTION OF THE SEVERAL VIEWS OF THE DRAWINGS

The following figures form part of the present specification and are included to further demonstrate certain aspects of the present invention. The invention may be better understood by reference to one or more of these figures in combination with the detailed description of specific embodiments presented herein.

FIG. 1A illustrates a front perspective view of a tripod mounting assembly in accordance with aspects of the present disclosure, in conjunction with a tripod.

FIG. 1B illustrates a rear perspective view of the mounting assembly of FIG. 1A.

FIG. 2 illustrates an exploded isometric view of an exemplary tripod suitable for use with the mounting assemblies of the present disclosure, in conjunction with an exemplary tripod mounting assembly.

FIG. 3 illustrates a top view of the tripod mounting assembly of FIG. 1.

FIG. 4 illustrates a back view of the tripod mounting assembly of FIG. 1.

FIG. 5 illustrates a side view of the tripod mounting assembly of FIG. 1.

FIG. 6 illustrates an alternate side view of the tripod mounting assembly of FIG. 5, rotated 180°.

FIG. 7 illustrates a front end view of the mounting assembly of FIG. 1.

FIG. 8 illustrates a back end view of the mounting assembly of FIG. 7, rotated 180°.

FIG. 9 illustrates an alternative embodiment of a tripod mounting assembly in accordance with the present disclosure.

FIG. 10 illustrates a further embodiment of a tripod mounting assembly in accordance with the present disclosure.

While the inventions disclosed herein are susceptible to various modifications and alternative forms, only a few specific embodiments have been shown by way of example in the drawings and are described in detail below. The figures and detailed descriptions of these specific embodiments are not intended to limit the breadth or scope of the inventive concepts or the appended claims in any manner. Rather, the figures and detailed written descriptions are provided to illustrate the inventive concepts to a person of ordinary skill in the art and to enable such person to make and use the inventive concepts.

### DETAILED DESCRIPTION

The Figures described above and the written description of specific structures and functions below are not presented to limit the scope of what Applicants have invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. While the present invention will be described with reference to a few specific embodiments, the description is illustrative of the invention and is not to be construed as limiting the invention. Various modifications to the present invention can be made to the preferred embodiments by those skilled in the art without departing from the true spirit and scope of the invention as defined by the appended claims. It will be noted here that for a better understanding, like components are designated by like reference numerals throughout the various figures. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims. The terms “couple,” “coupled,” “coupling,” “coupler,” and like terms are used broadly herein and may include any method or device for securing, binding, bonding, fastening, attaching, joining, inserting therein, forming thereon or therein, communicating, or otherwise associating, for example, mechanically, magnetically, electrically, chemically, directly or indirectly with intermediate elements, one or more pieces of members together and may further include without limitation integrally forming one functional member with another in a unity fashion. The coupling may occur in any direction, including rotationally.

Applicants have created a versatile, adjustable mounting assembly for use with a variety of portable imaging devices, including cell phones with cameras and video recorders which allows the imaging device to be attached to a tripod for use in stable photograph imaging, digital imaging, videography, or combinations thereof.

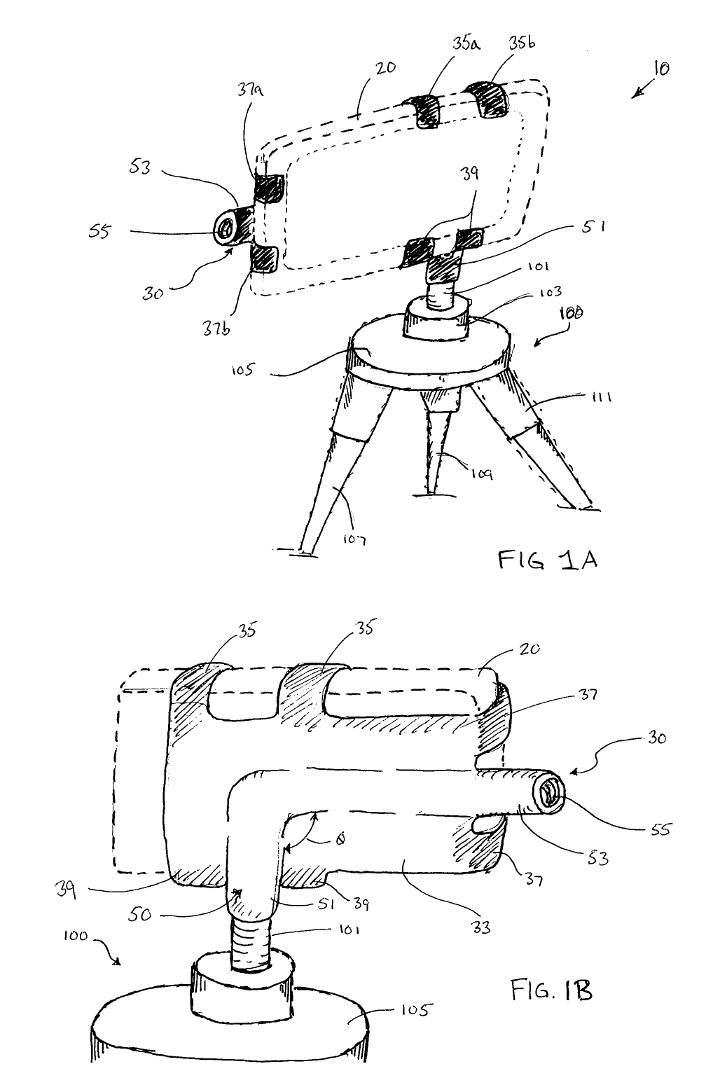

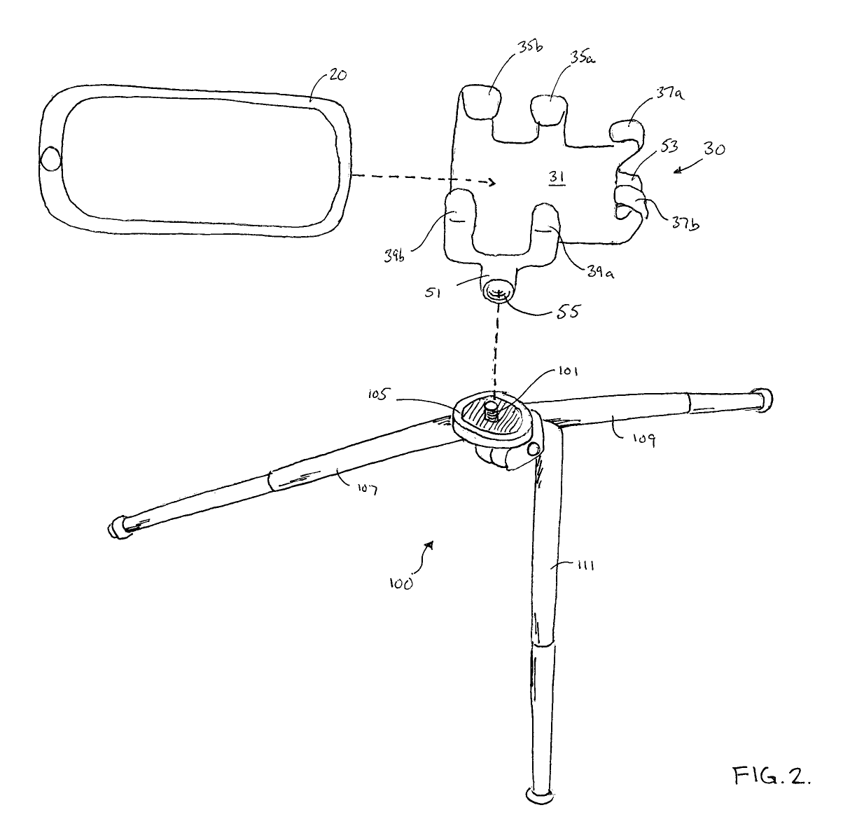

Turning now to the figures, FIG. 1A is an illustration of a front perspective view of an exemplary mounting assembly in accordance with the present disclosure, in place on a typical tripod. FIG. 1B is a back perspective view of the same exemplary mounting assembly shown generally in FIG. 1A. FIG. 2 illustrates an exploded view of the assembly and use of an exemplary mounting assembly in accordance with the present disclosure. These figures will be discussed in combination with each other.

FIG. 1A illustrates an imaging system 10 in accordance with the present disclosure, the system comprising a directionally-adjustable mounting assembly 30 suitable for use with a portable imaging device 20, and a stand which may be operably connected to the mounting assembly 30 via connector 50. In accordance with aspects of the present disclosure, the mounting assembly 30 is used to retain a portable imaging device 20 such as (but not limited to) an iPod®, iPhone®, Android®, mobile phone, portable videophone, or other suitable portable-imaging device in place and simultaneously allow the device to be connected to a tripod or equivalent stand or retaining means so that more stable and remotely-activated (e.g., via a timer) photographs and videos may be taken by the user. Advantageously, as discussed herein, the mounting assembly of the present disclosure allows for a portable imaging device 20 such as a mobile phone with imaging (camera) capabilities to be affixed to a tripod or similar stand assembly for placing on a surface such that the portable imaging device can be placed without movement during shooting for taking an object's image (e.g., a self-photograph), or a video image series, with the imaging device. A further advantage of the mounting assembly, e.g. assembly 30, disclosed herein is the flexible adjustability of the size of the retaining void formed by the arms 35, 37, 39, such that the mounting assembly 30 can accommodate a variety of portable imaging devices of varying thicknesses, and with or without protective covers or decorative mobile device ‘skins’. As used herein, the term “mounting assembly” refers to a holder having a shape for receiving and supporting a portable imaging device, such as a cell phone having camera and/or video capabilities, in a manner that leaves the control and display functions of the portable imaging device visible and accessible to the user. Such a holder also allows for electrical connectors to be attached to the imaging device, allowing for the imaging device to operably receive an electrical charge or other electrical signal (such as a remote shutter control) while the imaging device is received and supported in the holder.

The stand (e.g., tripod 100 as illustrated generally in the figures) for securing the portable imaging device 20 thereto and positioning the device on the ground or on any suitable, desired surface upon which the stand may be securely attached is coupled to the mounting assembly 30. FIG. 1A is a schematic view illustrating one example of a stand or tripod 100 suitable for use with the mounting assembly of the present disclosure. As shown in FIG. 1A, and partially in FIG. 1B, the stand/tripod 100 includes a body 105 and legs 107, 109, 111 connected to the body 105 in a manner which allows the legs to be spread out by a predetermined angle. Each of the legs 107, 109, 111 may also optionally be unfolded and folded, independently, until a desired length is reached. As is well known, each leg may comprise a plurality of hollow tubes or equivalent height-adjusting means, typically overlapped for telescopically adjusting the overall length of the legs individually. A threaded connecting bolt 101 extends by a predetermined height from a top surface of the tripod 100. As shown in FIG. 2, the bolt 101 can be screwed or otherwise threadably attached into a connector opening 55 of the mounting assembly 30, for example, by rotating a rotary means 103 in the tripod 100 for coupling the mounting assembly containing an imaging device 20 to the tripod 100. In typical use, as illustrated generally in FIG. 2, imaging device 20 is slidably inserted into the receiving portion of the mounting assembly 30 formed by adjustable arms 35, 37 and 39. The assembly/imaging device system is then coupled to the receiving portion of the tripod 100 via the appropriate connector means 55 on assembly 30 so as to orient the imaging device 20 as desired by the user.

The body of the assembly 30 may be made of any number of appropriate materials, including metal, wood, or a polymer or resin such as ABS (poly(acrylonitrile, butadiene, styrene)) or polypropylene, as well as all thermoplastic materials, some thermoset materials, and some elastomeric materials, wherein it is most preferable for cost and manufacturing reasons to form the body 33 using an injection molded plastic or polymer material such as ABS, nylon, polyethylene, polypropylene, or polystyrene. Attachment means 35, 37, 39 may be flexible/thickness-adjustable arms, wires, or clasps that are also preferably coated with an appropriate material, such as PVC (polyvinylchloride) or polyolefin. For example, in one non-limiting example, the attachment means 35, 37, 39 of FIGS. 1-8 are tab-like arms made of a flexible material (such as a bendable metal, moldable metal or polymer) that are plastic (e.g., PVC or polyolefin) coated.

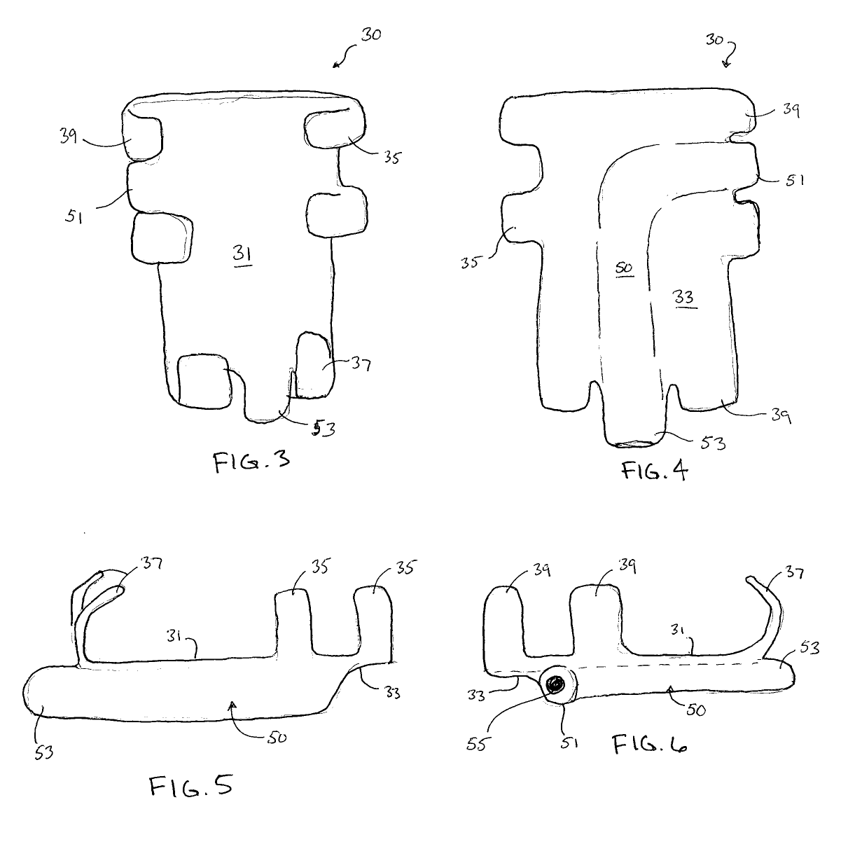

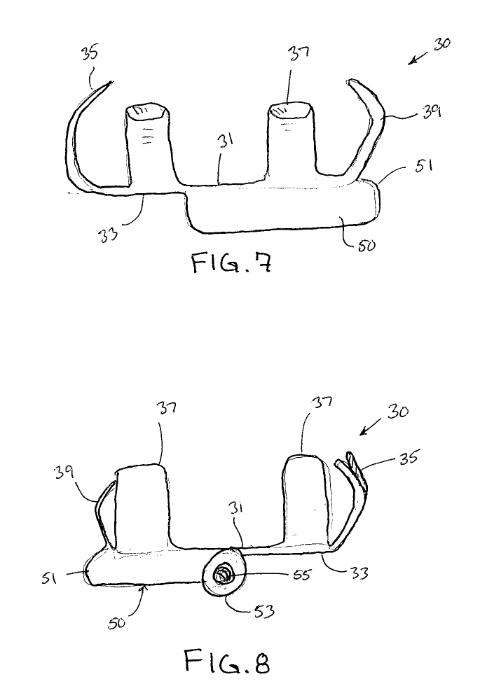

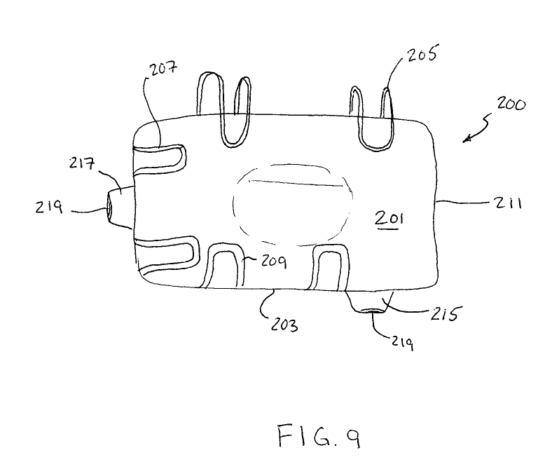

With reference to FIGS. 3-8, FIG. 3 illustrates a top, face-view of the mounting assembly 30 of FIG. 1A and FIG. 1B. FIG. 4 illustrates a rear view of the mounting assembly 30; FIG. 5 illustrates a side view of the mounting assembly 30 of FIG. 3; FIG. 6 illustrates a side view of the mounting assembly 30 of FIG. 5, rotated 180°. FIG. 7 illustrates a face-on front view of the mounting assembly 30 of FIG. 3; and, FIG. 8 illustrates a face-on rear view of the mounting assembly 30 of FIG. 3, showing the assembly of FIG. 7 rotated 180°. These figures will be described in conjunction with each other.

As is evident from FIG. 3 and the associated figures, the mounting assembly 30, alternatively referred to as imaging device holder, comprises an integral, multi-directional connector 50, wherein the adjustable terminal support provides one or more degrees of freedom to the camera-equipped wireless communications device (e.g., an iPhone, Droid™, or the like). In particular, the mounting assembly 30 comprises a central backing plate having a front face 31, and an opposite, substantially parallel back face 33. Extending from at least two, and preferably from three, sides or edges of the backing plate 40 are flexible or adjustable attachment arms 35, 37 and 39. The mounting assembly 30 also comprises a connector assembly 50 operably connected to the back face 33 of the backing plate itself. Optionally, the connector assembly may be integrally formed with the backing plate itself during manufacture, as appropriate.

Attachment arms 35, 37 and 39, which may be single arms, or pairs of arms as shown in the figures, act to shape the interior region of the holder/mounting assembly, and allow this interior region to be shaped as appropriate in order to allow for imaging devices of differing sizes, shapes, and/or thicknesses to be used with the instant device. Typically, one arm or set of arms extends outwardly from a first edge 41 of the backing plate 40 of assembly 30, a second arm or set of arms extends outwardly from a second edge 45 perpendicular to the first edge, and a third set of arms extends outwardly from a third edge 47 of the assembly 30, the third edge being substantially parallel to the first edge of the backing plate and substantially perpendicular to the second edge of the backing plate. In accordance with certain aspects of the disclosure, the arms, which may be either singular or in pairs as illustrated in the Figures, are oriented such that the arms on the first and third edges are substantially aligned with each other. Alternatively, and equally acceptable, the arms extending from the first and third edges may be offset from each other, e.g., the first set of arms 35a, 35b may be located at or near the leading edge 41 of the backing plate 40, while the third set of arms 39a, 39b may be located closer to the back edge 45 of the backing plate.

Attachment arms 35, 37 and 39 are flexible arms, made of an appropriate flexible material, such that they are manually foldable upward toward front face 31 of the assembly 30, and inward toward the center of the backing plate 40. This is shown perhaps most clearly in FIG. 5-FIG. 8. The flexibility of the arms 35, 37 and 39 allow for the interior region of the holding device to be adjust for imaging devices of varying thicknesses and dimensions as desired, and allow for multiple devices to be used with a single device 30.

Connector assembly 50, as indicated above, may be either integrally formed with the backing plate itself during manufacture, or may be operably attached using any appropriate attachment means in association with the material of the backing plate. As illustrated in the figures, most specifically FIG. 4, connector assembly 50 is an elongated member that comprises two connection ends, first connection end 51 and second connection end 53, which are spaced apart and oriented substantially perpendicular to each other. Optionally, and equally acceptable, while not shown in the figures, the assembly may be adjustable, such as by way of a central adjustment feature that interconnects the connection ends 51 and 53, and allows them to be oriented in a variety of angles θ between about 35° and about 90° with respect to each other (e.g., about 45°, about 60°, and about 75° relative to each other). At the terminal connection ends 51 and 53 is a connection means, such as a female receiving portion 55, which may be a threaded female opening as illustrated generally in the figures, or other appropriately shaped female receiving portion adapted to receive a corresponding male engagement means on the stand or tripod 100, such as threaded bolt 101.

As indicated above, mounting assembly 30 may be manufactured from any suitable material, including but not limited to injection molded polymers or plastics or resins, steel, aluminum, copper alloy, aluminum, non-plated steel, or steel plated with a metal selected from the group consisting of copper, nickel, brass, bronze, nickel zinc alloy, zinc and combinations thereof, as well as any number of other metal alloys, the only requirement being that the metal substrate used in at least the backing plate have a hardness value of about 4 GPa or more, and/or a yield strength of about 2 GPa or more, as determined by the Vickers or Knoop hardness test or the appropriate ASTM strength test. In the event that the assembly 30 is manufactured from an injected molded plastic or polymer, any suitable polymer which can be used in injection molding manufacturing processes may be used, including but not limited to polypropylene, polyethylene, block co-polymers, and ABS (poly(acrylonitrile, butadiene, styrene)) polymers having the chemical formula (C₈H₈)ₓ.(C₄H₆)_{y}.(C₃H₃N)_{z}). Further, in accordance with certain aspects of the present disclosure, the material which the assembly 30 is made from may be further treated, such as by applying a powder-coating, so as to affect both the aesthetics of the device and provide added surface protection to the device. In accordance with further aspects of the instant disclosure, the assembly 30 may be coated, partially or substantially in total, with a polymer or elastomeric coating, or a carbon-fiber coating. Exemplary polymers suitable for use in coating the outer surfaces of devices of the present disclosure include, but are not limited to, polymers selected from the group consisting of polyvinyl chloride (PVC), polyolefins, polytetrafluoroethylene, polyvinylidene fluoride, polyvinyl-fluoride, ethylene chlorotrifluoroethylene copolymer, ethylene-tetrafluoroethylene-copolymer, fluoroethylene-propylene copolymer, perfluoralkoxy polymer, polychloro-trifluoroethylene, polypropylene (PP), polyethylene (PE), polyethylene terephthalate (PET), and mixtures thereof. These polymers may be bound to the exterior surface of the substrate (here, the outer surface of the mounting assembly). In accordance with certain aspects of the present disclosure, the polymer used to coat the assembly has a melting point greater than about 200° C., and may also further optionally include a coloring agent. The polymer coatings, when included, may be applied to the substrate (e.g., the back plate or the arms 35, 37, 39) using an suitable method. Exemplary methods for applying the polymer to the substrate comprise a method selected from the group consisting of coil-coating, reverse roll-coating, film lamination, and co-extrusion.

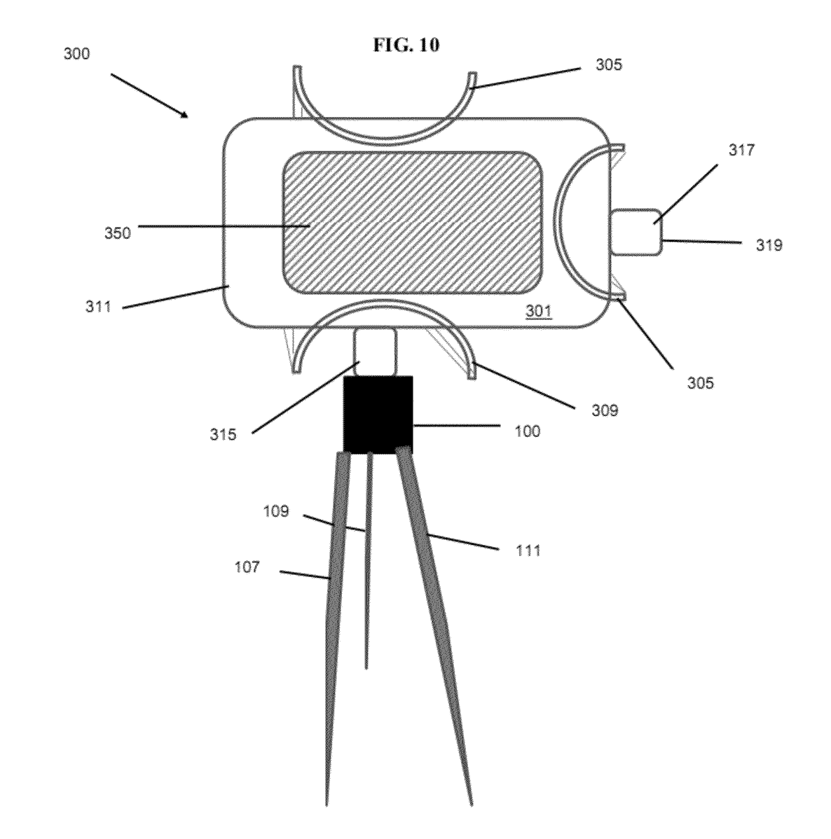

FIG. 9 illustrates an alternative embodiment for the mounting assembly in accordance with aspects of the present disclosure. As shown therein, mounting assembly 200 comprises a backing plate 202 having a front face 201, an opposite back face 203, and a leading edge 211, as well as side edges 203a, 203b, and 203c. The assembly also comprises a connector assembly 250 having interconnected first and second connection ends 215 and 217, respectively, with female receiving portions 219 formed in the connection ends. The connection ends 215 and 217 are preferably oriented substantially perpendicular to each other, as discussed in association with connector assembly 50 above. Mounting assembly 200 further comprises, as the retaining means, flexible retaining members 205, 207 and 209, which are formed of metal or metal alloy wire or other flexible, strand-like materials integrated into the backing plate of the assembly 200, and which may further be coated with a polymer or other protective coating to protect and minimize contact damage to the imaging device when it is retained and held within the assembly 200. Suitable polymer coatings are the same as those described above, such as polyvinyl chloride (PVC) or polyolefin-based polymers, including but not limited to the thermoplastic polyolefins polyethylene (PE), polypropylene (PP), polymethylpentene (PMP), and polybutene-1 (PB-1).

FIG. 10 illustrates yet another alternative embodiment for a mounting assembly, or retaining means, 300 in accordance with aspects of the present disclosure, attached to a portable tripod 100 with support legs 107, 109 and 111. As shown therein, mounting assembly 300 comprises a backing plate 302 having a front face 301, an opposite back face 303, and a leading edge 311, as well as side edges 303a, 303b, and 303c (similar to those shown in association with FIG. 9). The assembly also comprises a connector assembly 350 having first and second connection ends 315 and 317, respectively, which may be separate or inter-connected as appropriate, with female receiving portions 319 formed in the connection ends. The connection ends 315 and 317 are preferably oriented substantially perpendicular to each other, as discussed in association with connector assembly 50 above. Mounting assembly 300 further comprises, as the retaining means, flexible retaining members 305, 307 and 309, which are formed of metal or metal alloy wire or other flexible, strand-like materials integrated into the backing plate of the assembly 300, and which may further be coated with a polymer or other protective coating to protect and minimize contact damage to the imaging device when it is retained and held within the assembly 300. Suitable polymer coatings are the same as those described above, such as polyvinyl chloride (PVC) or polyolefin-based polymers, including but not limited to the thermoplastic polyolefins polyethylene (PE), polypropylene (PP), polymethylpentene (PMP), and polybutene-1 (PB-1).

The assemblies described herein may also further include additional features not specifically shown, such as the inclusion of a slip-resistance elastomeric or an open- or closed-cell foam material (e.g., neoprene, polystyrene, polyethylene, or the like) pad (see pad 250 in FIG. 9) attached to the front face of the backing plate so as to prevent the device from slipping once inserted within the holder and during use. One exemplary material that can be used is VOLARA® foam, available from a variety of commercial sources. Attachment to the backing plate is preferably by way of a suitable adhesive having long durability and which will not lose its adhesive value during use.

Other and further embodiments utilizing one or more aspects of the inventions described above can be devised without departing from the spirit of Applicant's invention. For example, the mounting assembly described herein can be made of different materials, or encompass a combination of features described herein. Further, the various methods and embodiments of the digital imaging mounting assembly can be included in combination with each other to produce variations of the disclosed methods and embodiments. Discussion of singular elements can include plural elements and vice-versa.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to fully protect all such modifications and improvements that come within the scope or range of equivalent of the following claims.

What is claimed is:

1. A holder for attachment to a tripod and having a shape for receiving and supporting imaging devices in a manner that leaves the control, display and image capturing functions of the device visible and accessible to a user, the holder comprising:
a planar backing plate having a front face, an opposite back face, and an open leading edge;
a first adjustable and articulatable retaining arm extending from a first edge of the backing plate;
a second adjustable and articulatable retaining arm extending from a second edge of the backing plate;
a third adjustable and articulatable retaining arm extending from a third edge of the backing plate; and
a multi-directional connector attached to the back face of the backing plate and having a first end and a spaced apart second end, the first end and second end having female receiving portions formed therein for coupling with the stand,
wherein the first arm is oriented substantially perpendicular to the second arm, and
wherein the first edge and the third edge are perpendicular to the leading edge of the backing plate.

2. The holder of claim 1, wherein the first, second and/or third retaining arms further comprise a polymer coating.

3. The holder of claim 1, wherein the backing plate is a solid plate.

4. A mounting assembly for receiving an imaging device and capable of coupling with a stand in order to take an object image with the imaging device coupled with the stand, the mounting assembly comprising:
a planar backing plate having a front face, an opposite back face, and an open leading edge;
a first adjustable and articulatable retaining arm extending from a first edge of the backing plate, the first edge being perpendicular to the leading edge;
a second adjustable and articulatable retaining arm extending from a second edge of the backing plate; and
a multi-directional connector attached to the back face of the backing plate and having a first end and a spaced apart second end, the first end and second end having female receiving portions formed therein for coupling with the stand,
wherein the first arm is oriented substantially perpendicular to the second arm.

5. The mounting assembly of claim 4, wherein the stand is a tripod.

6. The mounting assembly of claim 4, wherein the connection element of the mounting assembly is a female screw capable of coupling with a corresponding male screw of the stand.

7. The mounting assembly of claim 4, wherein the backing plate is a solid plate.

8. The mounting assembly of claim 4, wherein connector is integrally formed with the back face of the backing plate.

9. The mounting assembly of claim 4, further comprising a third adjustable and articulatable retaining arm, the third arm being oriented substantially parallel to the first arm and substantially perpendicular to the second arm.

10. The mounting assembly of claim 4, wherein the retaining arms are metal or metal alloy wires having a polymer coating.

11. A mounting means for receiving a hand-held imaging device, the mounting means comprising:
a planar support means having a front face, an opposite back face, and an open leading edge;
a first adjustable and articulatable retaining means extending from a first edge of the backing plate;
a second adjustable and articulatable retaining means extending from a second edge of the backing plate; and
a multi-directional connection means attached to the support means and having a female receiving portion formed therein for coupling with a separate support means,
wherein the first retaining means is oriented substantially perpendicular to the second retaining means.

12. The mounting means of claim 11, wherein the first and second retaining means are made of the same material, and are coated with a polymer.

13. The mounting means of claim 12, wherein the polymer is poly vinyl chloride or polyolefin.

14. The mounting means of claim 11, wherein the planar support means further comprises an open- or closed-cell foam pad attached to the front face.

15. The mounting means of claim 11, wherein the planar support is made of an injection molded plastic or resin material.

16. The mounting means of claim 15, wherein the plastic or resin material is selected from the group consisting of ABS, polypropylene, polystyrene, polyethylene, and thermoplastic materials.
